(19) United States
(12) Patent Application Publication
(10) Pub. No.: US 2011/0317300 A1
(43) Pub. Date: Dec. 29, 2011

(54) MAGNETIC TRANSFER MASTER SUBSTRATE, MAGNETIC TRANSFER METHOD AND METHOD OF MANUFACTURING THE SUBSTRATE

(75) Inventor: Shinji UCHIDA, Matsumoto-city (JP)

(73) Assignee: Fuji Electric Device Technology Co., Ltd., Tokyo (JP)

(21) Appl. No.: 13/084,317

(22) Filed: Apr. 11, 2011

(30) Foreign Application Priority Data
Jun. 24, 2010 (JP) 2010-143955

(51) Int. Cl. G11B 5/86; C23F 1/00

(52) U.S. Cl. 360/17; 216/22; G9B/5.308

(57) ABSTRACT

A magnetic transfer master substrate may have a ferromagnet pattern corresponding to a signal array. The substrate may include a non-magnetic base having depressed portions, formed on a surface thereof, which correspond to the signal array. A ferromagnet may be disposed in the depressed portions and includes a portion protruding above said surface. A section through the portion of the ferromagnet protruding from said surface taken perpendicularly to a surface of the substrate, includes a curved corner, a radius of curvature of which is no less than 2 nm and no more than 10 nm. The ferromagnet protrudes from the surface of the base by a distance no less than 2 nm and no more than 15 nm. A magnetic transfer method may include bringing the master substrate and a magnetic recording medium into contact and applying a magnetic field to record a magnetization pattern.

### CROSS-REFERENCE TO RELATED APPLICATION

This application claims priority under 35 U.S.C. §119 from Japanese Patent Application No. 2010-143955, filed on Jun. 24, 2010, the entirety of which is incorporated herein by reference.

### BACKGROUND OF THE INVENTION

1. Technical Field

The present invention relates to a magnetic recording medium. More particularly, the magnetic recording medium of the invention relates to a magnetic recording medium wherein there is no need to separately write servo information. Also, the invention includes a magnetic recording medium manufacturing method whereby servo information can be easily recorded.

2. Related Art

In a general HDD device, a head is caused to fly about 10 nm above a magnetic recording medium, and a data read/write is carried out. Bit information on the magnetic recording medium is stored in concentrically disposed data tracks. The magnetic head is positioned above the data tracks when reading or writing data. Servo data for the positioning is recorded at constant angle intervals with respect to the data tracks on the magnetic recording medium. As is generally often the case that the servo information is recorded using a magnetic head, a problem has occurred in that a write time has increased along with an increase in recording tracks in recent years, and the production efficiency of the HDD has dropped.

Bearing in mind this problem, a method has been proposed whereby, instead of writing the servo information using the magnetic head, the servo information is recorded en bloc on the magnetic transfer medium by means of a magnetic transfer technique, using a master substrate bearing the servo information. For example, a method is disclosed in JP-A-2002-83421 whereby, using a kind of master substrate on which a servo pattern is formed with a ferromagnet, the servo information of the master substrate is transferred to a perpendicular recording medium.

As the master substrate is repeatedly brought into direct contact with and separated from the magnetic transfer medium, deformation and losses of the ferromagnet on the master substrate develop along with the repeated use, and a strength degradation or loss of a recording signal occurs. Therefore, relating to the configuration of a master substrate for solving this, for example, JP-A-2000-195046, Japanese Patent No. 3,343,343, and Japanese Patent No. 3,329,259 have been disclosed.

JP-A-2000-195046 discloses a magnetic transfer master carrier that transfers recording information to a magnetic recording medium, wherein there are a plurality of transfer information recording portions, configured of a ferromagnet, corresponding to transfer recording information, a non-magnetic material portion that segregates the transfer information recording portions exists between adjacent transfer information recording portions, and the surfaces of the transfer information recording portions and the surface of the non-magnetic material portion essentially form the same plane. The thickness of the transfer information recording portions is 20 to 1,000 nm. Also, in JP-A-2000-195046, being essentially the same plane means that, specifically, the level difference between the portions in which there is a magnetic layer and the portions in which there is no magnetic layer is 30 nm or less, and preferably 10 nm or less.

Japanese Patent No. 3,343,343 discloses a master information carrier including depressed portions formed in positions corresponding to a magnetization pattern, wherein a ferromagnetic thin film is formed in the depressed portions, and the ferromagnetic thin film is formed in such a way that its surface protrudes from one principle surface on the depressed portion side of a base, and the level difference between the surface of the ferromagnetic thin film and the one principle surface of the base is 200 nm or less (excepting a case in which it is 30 nm or less).

Also, in another aspect of Japanese Patent No. 3,343,343, there is disclosed a master information carrier including the base in which the depressed portions are formed in positions corresponding to the magnetization pattern, and a ferromagnetic thin film formed in the depressed portions in such way that its surface is disposed inside the depressed portions, wherein the distance between the one principle surface on the depressed portion side of the base and the surface of the ferromagnetic thin film is 100 nm or less (excepting a case in which it is 30 nm or less).

Japanese Patent No. 3,329,259 discloses a master substrate wherein, as a first configuration, a formation pattern corresponding to an information signal array is provided on the surface of a non-magnetic base by means of an array of ferromagnetic thin films deposited on the base surface, and a non-magnetic solid is packed between adjacent ferromagnetic thin films in the array of ferromagnetic thin films. Also, there is disclosed a master substrate wherein, as a second configuration, a formation pattern corresponding to an information signal array is provided by means of an array of depressed portions formed on the base surface, and a ferromagnetic thin film is packed into the depressed portions formed on the base surface. Also, it is also disclosed that, with either configuration, a hard protective film is formed on the surfaces of the ferromagnetic thin film and non-magnetic base.

Also, JP-A-2009-295250 discloses a magnetic transfer master carrier wherein a magnetic layer is formed on a side surface of the magnetic transfer master carrier, as well as on a leading edge surface of a protruding portion thereof. Furthermore, the leading edge of the protruding portion may also be chamfered in order that it connects easily with the magnetic layer extending from the side surface, easily forming a continuous magnetic film.

Also, JP-A-2003-178440 discloses a magnetic transfer master carrier wherein a protruding portion of a pattern formed on the master carrier has a spherical apex in order that, after the master carrier and a slave medium are brought into contact and a magnetic transfer is carried out, the two are easily separated from each other, and no damage is caused to the slave medium.

Year by year, pattern dimensions are being miniaturized along with an increase in recording density. For this reason, it has become necessary in recent years that a ferromagnet pattern of a master substrate corresponding to a signal array for transferring an information signal to a magnetic recording medium is also given a pitch of 100 nm or less. In this kind of situation, with the kinds of structure of the master substrates disclosed in the heretofore known Japanese Patent No. 3,343,343 and Japanese Patent No. 3,329,259 wherein the surface of the ferromagnet protrudes above the surface of the non-magnetic base, it happens that, by the pattern being miniaturized, the master substrate becomes bad because of a servo defect due to a reduction of an output signal caused by a slight gap or deformation in the edge of the ferromagnet pattern.

Also, although it is ideal for a magnetic transfer from a master substrate that the surface of the non-magnetic base and the surface of the ferromagnet meet in a perfectly smooth condition, in actual manufacture, it is difficult to create a perfectly smooth structure over the whole surface of all master substrates produced because of a variation in deposited film thickness, etching rate error, a variation in in-plane uniformity, and the like. Also, there being the surface roughness of the master substrate, a biting on microscopic particles, and the like, even with a smooth surface wherein the surface of the non-magnetic base and the surface of the ferromagnet meet in a perfectly smooth condition, a slight space occurs between the master substrate and the magnetic recording medium, and the slight space becomes a cause of hindering a sufficient magnetic transfer. For this reason, the kind of structure disclosed in the quoted JP-A-2000-195046, wherein the surface of the ferromagnet is in a smooth condition, or depressed, with respect to the surface of the non-magnetic base, ceases to be desirable.

With regard to the manufacture of this kind of high recording density magnetic recording medium with a track pitch of 100 nm or less, we have found that it is necessary to make the space between the ferromagnet and magnetic recording medium in the magnetic transfer step 2 nm or less. When the surface of the ferromagnet is depressed 2 nm or more below the surface of the non-magnetic base, the strength of a signal transferred to the magnetic recording medium decreases, and the servo signal cannot be accurately read.

Furthermore, it has been found that the cross-sectional form of the portion of the ferromagnet protruding above the surface being of a specific form is effective in preventing a reduction of the output signal due to a gap or deformation in the edge of the ferromagnet pattern in a master substrate with a track pitch of 100 nm or less.

### SUMMARY OF THE INVENTION

One aspect of the invention relates to a magnetic transfer master substrate having a ferromagnet pattern corresponding to a signal array for transferring an information signal therein to a magnetic recording medium. The substrate includes a non-magnetic base having depressed portions, formed on a surface thereof, corresponding to the signal array. The substrate further includes a ferromagnet, disposed in the depressed portions and including a portion protruding above said surface, wherein a section through the portion of the ferromagnet protruding from said surface taken perpendicularly to a surface of the substrate, includes a curved corner, a radius of curvature of which is no less than 2 nm and no more than 10 nm. The ferromagnet protrudes from the surface of the base by a distance no less than 2 nm and no more than 15 nm.

A magnetic transfer method may be used to record a magnetization pattern corresponding to the ferromagnet pattern of the master substrate, on a magnetic recording medium. The method includes bringing the master substrate and the magnetic recording medium into contact, one on top of the other. A magnetic field is applied to the contacting master substrate and magnetic recording medium, and a magnetization pattern corresponding to the ferromagnet pattern of the master substrate, is recorded on the magnetic recording medium. The contacting master substrate and magnetic recording medium may then be separated.

One aspect of the present invention relates to a method of manufacturing a magnetic transfer master substrate having a ferromagnet pattern corresponding to a signal array for transferring an information signal therein to a magnetic recording medium. The method comprises providing a non-magnetic base. Depressed portions, corresponding to the signal array, may be formed in a surface of the base. A ferromagnet is deposited on said surface of the base including in the depressed portions. The base and the ferromagnet are etched at a lower etching rate for the ferromagnet than for the base so as to form the ferromagnetic pattern. The ferromagnet may protrude from said surface of the base by a distance no less than 2 nm and no greater than 15 nm. A section of the ferromagnet that protrudes from the surface of the base, and that is taken perpendicularly to a surface of the substrate, includes a curved corner, a radius of curvature of which is no less than 2 nm and no more than 10 nm.

The invention provides a magnetic transfer master substrate, and a manufacturing method thereof, that improve durability and magnetic transfer performance in the manufacture of a high recording density magnetic recording medium with a track pitch of 100 nm or less.

### BRIEF DESCRIPTION OF THE DRAWINGS

FIG. 1 is a sectional view of a magnetic transfer master substrate of the invention;

FIG. 2 is an enlarged view of one portion of FIG. 1;

FIGS. 3a to 3d are sectional views showing a manufacturing method of the invention; and

FIGS. 4(a) and 4(d) are sectional views showing a magnetic transfer method of the invention.

### DETAILED DESCRIPTION OF THE INVENTION

Hereafter, a description will be given of an embodiment of the invention. The embodiment shown hereafter being merely one example of the invention, those skilled in the art will be able to change the design as appropriate.

Magnetic Transfer Master Substrate and Manufacturing Method Thereof.

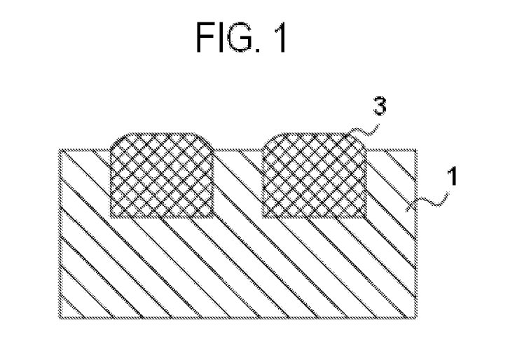

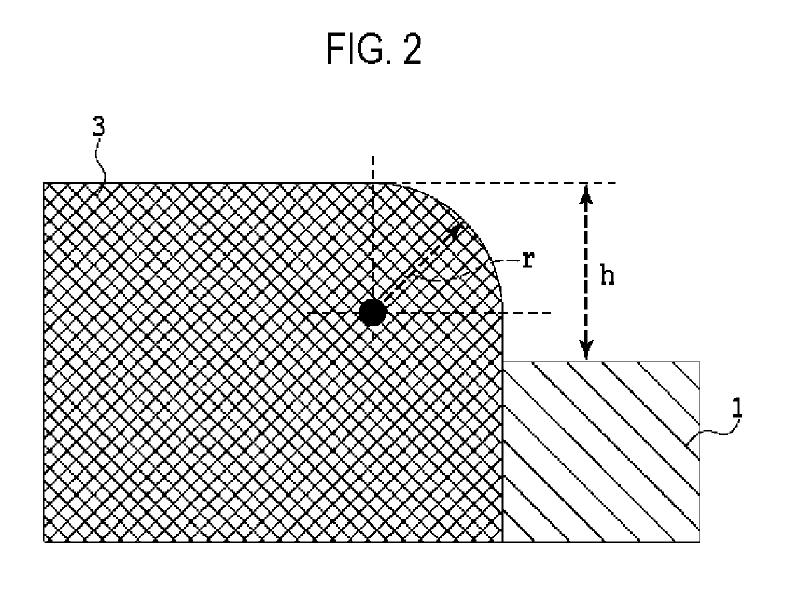

FIG. 1 is an example of a magnetic transfer master substrate of the invention, and FIG. 2 is an enlarged view thereof. The master substrate of the invention is such that depressed portions corresponding to a signal array are formed in the surface of a non-magnetic base 1, and a ferromagnet 3 is embedded in the depressed portions in such a way that one portion thereof protrudes above the surface of the non-magnetic base 1 (refer to FIG. 1). Also, the master substrate of the invention is such that a radius of curvature r of a corner portion of a cross-section of the portion of the ferromagnet 3 protruding above the surface of the non-magnetic base 1 when cutting perpendicularly to the substrate is 2 nm or more, 10 nm or less, and a height h of the portion of the ferromagnet 3 protruding above the surface of the non-magnetic base 1 is 2 nm or more, 15 nm or less (refer to FIG. 2).

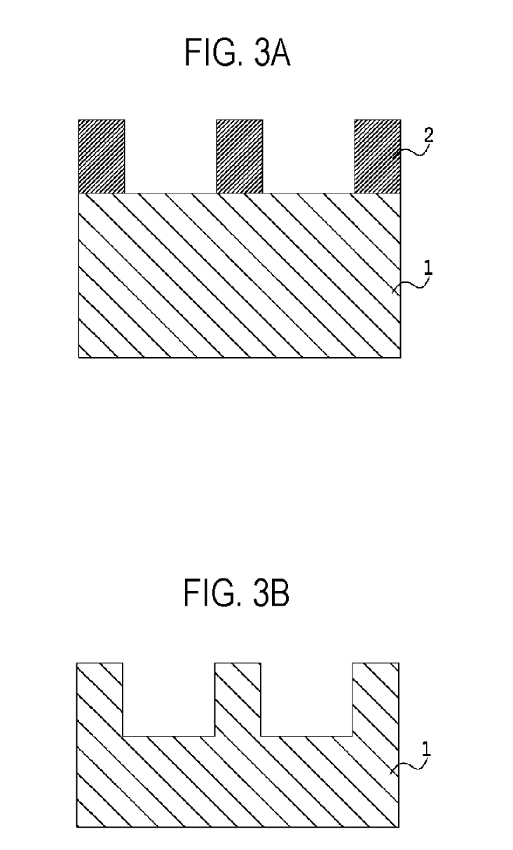

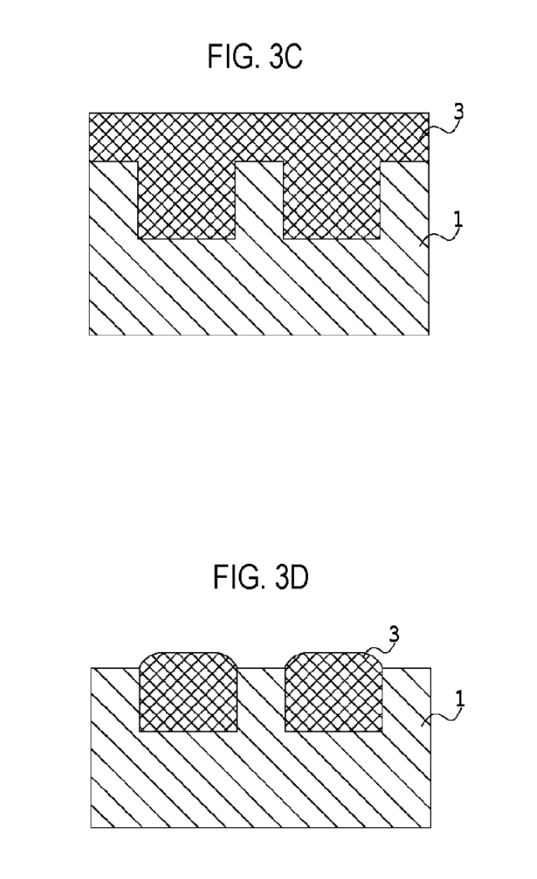

Next, a description will be given of a manufacturing method of the master substrate of the invention, using FIGS. 3a to 3d.

The invention is such that, firstly, a resist film 2 is formed on a non-magnetic base 1, and the resist film 2 is patterned in accordance with information to be transferred (FIG. 3a). Specifically, the resist film 2 is removed from places in which a ferromagnet 3 is to be embedded.

The non-magnetic base 1 may be the substrate itself, or may be another non-magnetic body deposited on the substrate as a pattern formation film. Owing to their non-magnetism, workability, and versatility, Si, SiO₂, Al, Al₂O₃, or a compound thereof, can be used for the non-magnetic base 1. Also, a non-magnetic metal such as Ti, Cr, or Al, carbon, Si, glass, spin on glass (SOG), or the like, can also be utilized for the pattern formation non-magnetic body film. Also, a common deposition method such as a sputtering method or a CVD method can be utilized as the deposition method.

It being sufficient that the resist film 2 has process tolerance and sufficient removal performance in a step of etching the non-magnetic base 1, it can be selected in accordance with the patterning method. The patterning of the resist film 2 may be achieved by an exposure to and subsequent development by an electron beam, or a nanoimprint lithography may be used. In the case of the exposure to and development by the electron beam, a common electron beam-use resist can be used as the resist film 2 owing to its exposure and development performance, and process tolerance and removal performance in the next etching step. In the case of the nanoimprint lithography, by pressing a stamper on which an irregular pattern is formed against the surface of the resist applied on the non-magnetic base 1, the irregular pattern of the stamper is transferred to the resist film 2. There are an optical imprint, a thermal imprint, and a room temperature imprint, depending on differences in irregularity transfer methods, and any one of them can be used. Owing to their transferability, and process tolerance and removal performance in the non-magnetic base 1 etching step, it is possible to use a polymethylmethacrylate (PMMA) resin, an acrylic light-curing resin, an SOG including an organic material, a polyimide resin, or the like, for the resist film 2 to be patterned by the nanoimprint lithography.

After the patterning of the resist film 2, the non-magnetic base 1 is etched using the pattern of the resist film 2 as a mask, after which the resist film 2 is removed, forming the irregular pattern of the non-magnetic base 1 (FIG. 3b). The processing of the non-magnetic base 1 can be carried out by various kinds of etching, such as a reactive ion etching (RIE), an ion beam etching (IBE), or a wet etching, by selecting the material of the non-magnetic base 1 and the material of the resist film 2. The removal of the resist film 2 too can be carried out with a wet method using a stripping liquid, or a dry etching such as the RIE or IBE.

Also, it is acceptable to form in advance a second thin film (not shown), which is a mask when processing the non-magnetic base 1, on the surface of the non-magnetic base 1, etch the second thin film with the pattern of the resist film 2 as a mask, then process the non-magnetic base 1 with the patterned second thin film as a mask. For example, a Si substrate may be used as the non-magnetic base 1, carbon as the second thin film, and an SOG as the resist film 2. After depositing carbon as the second thin film on the Si substrate by sputtering, and forming the pattern of the SOG resist film 2 on the carbon thin film, it is possible to pattern the carbon thin film with a reactive ion etching (RIE) using oxygen gas, and subsequently process the Si substrate with an RIE using CF₄ gas, with the carbon thin film as a mask.

Also, the irregular pattern of the non-magnetic base 1 may also be formed without using a masking thin film such as the resist 2. For example, it is possible to form a non-magnetic film on the substrate, and form an irregular pattern on the film using a room temperature nanoimprint lithography or thermal imprint lithography. In view of the fact that the non-magnetic film ultimately remains on the master substrate, and needs to be of a durability that can withstand being brought into contact with and detached from a magnetic recording medium during a magnetic transfer, an SOG or polyimide resin is preferable.

After the irregular pattern is formed on the non-magnetic base 1, the ferromagnet 3 is deposited over the irregular pattern of the non-magnetic base 1 (FIG. 3c). The film thickness at this time, being such that the ferromagnet 3 fills the depressed portions in the surface of the non-magnetic base 1, and furthermore, the ferromagnet 3 accumulated in the depressed portions is higher than the surface of the non-magnetic base 1, is preferably 2 nm or more. Preferably, the surface of the ferromagnet 3 is approximately flat for the sake of convenience in a subsequent step.

It is possible to utilize Fe, Co, Cr, Ni, or an alloy including one or more thereof, as the ferromagnet 3. FeCo, FePt, or the like, which have a high saturation magnetization, are more preferable. It is possible to use a sputtering method, a vapor deposition method, a plating method, or the like, for the deposition of the ferromagnet 3.

Subsequently, the non-magnetic base 1 and ferromagnet are processed, forming the magnetic transfer master substrate (FIG. 3d).

In the master substrate, it is preferable from the point of view of the durability of the master substrate that the radius of curvature of the corner portion of the cross-section of the portion of the ferromagnet 3 protruding above the surface of the non-magnetic base 1 when cutting perpendicularly to the substrate is 2 nm or more. When the radius of curvature of the corner portion is less than 2 nm, the durability decreases, and a partial loss of servo signals, or a portion with low signal strength, is liable to occur.

Furthermore, it is preferable from the point of view of the signal characteristics of a magnetic recording medium to which a magnetic transfer is made that the radius of curvature of the corner portion is 10 nm or less. When the radius of curvature is more than 10 nm, noise occurs in the servo signal in a drive evaluation. It is thought that this is because the magnetic flux concentration at the edge portion of the ferromagnet pattern at a time of a magnetic transfer is incomplete, and becomes a source of noise.

Also, it is preferable that the height of the portion of the ferromagnet 3 protruding above the surface of the non-magnetic base 1 is 2 nm or more, 15 nm or less. When the height is less than 2 nm, a portion in which the signal strength is low appears in the servo signal in the drive evaluation. It is thought that this is because a space occurs between the ferromagnet and magnetic transfer medium at the time of the magnetic transfer step due to a reason such as the surface roughness of the non-magnetic base or a biting on microscopic particles. Also, when the height is more than 15 nm, the durability decreases, and a partial loss of servo signals, or a portion with low signal strength, is liable to occur.

The processing of the non-magnetic base 1 and ferromagnet 3 can be carried out by a dry etching, wet etching, or chemical mechanical polishing (CMP). Specifically, materials and/or etching conditions wherein the etching rate of the non-magnetic base 1 is higher than the etching rate of the ferromagnet 3 are selected. By choosing these kinds of material and/or etching conditions, the processing amount of the non-magnetic base 1 is greater than the processing amount of the ferromagnet 3, and it is possible to fabricate a master substrate of a shape such that the ferromagnet 3 protrudes from the non-magnetic base 1.

Furthermore, in order to smoothen the corner portion of the portion of the ferromagnet 3 protruding from the non-magnetic base 1, and control the radius of curvature of the corner portion, it is possible to use the following kind of method.

In a dry etching using a reactive ion etching (RIE), the smaller the ratio of the RF power to the substrate bias is made, the larger the radius of curvature becomes. For example, the ratio of the RF power to the substrate bias is 1 to 50. Preferably, it is 1 to 20. From the point of view of the controllability of the etching amount and radius of curvature of the corner portion, and of magnetic characteristic damage to the ferromagnet 3, it is preferable that the RF power is 10 to 1,500 W, and it is preferable that the substrate bias is 5 to 800 W.

Also, in a range in which the etching rate of the ferromagnet 3 is smaller than that of the non-magnetic base 1, the bigger the gas type selected makes the etching rate of the ferromagnet 3, the larger it is possible to make the radius of curvature. For example, the ratio of the etching rate of the ferromagnet to the etching rate of the non-magnetic base may be 1 to 50, and is preferably 2 to 5. For example, when the non-magnetic base 1 is of a carbon-based material, and the ferromagnet 3 is an FeCo alloy, the etching rate of the carbon-based material is reduced by reducing the proportion of O₂ gas in a mixed gas of Ar and O₂, within a range in which the etching rate of the FeCo alloy is smaller than the etching rate of the carbon-based material. As a result of this, the ratio of the etching rate of the FeCo alloy with respect to that of the carbon-based material increases, and the radius of curvature becomes larger. In the same way, when the non-magnetic base 1 is of a Si-based material, and the ferromagnet 3 is an FeCo alloy, the ratio of the etching rate of the FeCo alloy with respect to that of the Si-based material increases, and the radius of curvature becomes larger, by reducing the CF₄ content of the etching gas.

Furthermore, the lower the degree of vacuum when etching, the larger it is possible to make the radius of curvature. From the point of view of controlling the radius of curvature and of the stability of the RF plasma, a degree of vacuum of 0.05 to 10 Pa is preferable.

Meanwhile, in the case of a wet etching using a chemical mechanical polishing (CMP), in a range in which the etching rate of the ferromagnet 3 is small with respect to that of the non-magnetic base 1, the finer the grains of the slurry agent selected makes the etching rate of the ferromagnet 3 higher and it is possible to make the radius of the curvature larger. For example, when the non-magnetic base 1 is of a carbon-based material, and the ferromagnet 3 is an FeCo alloy, the ratio of the etching rate of the FeCo alloy is increased with respect to that of the carbon-based material by reducing the pressing pressure of the polishing pad when polishing, or making the abrasive grains of the slurry finer, and it is possible to make the radius of curvature of the corner portion of the ferromagnet larger.

Also, when the non-magnetic base 1 is of a carbon-based material, and the ferromagnet 3 is an FeCo alloy, the ratio of the etching rate of the FeCo alloy is increased with respect to that of the carbon-based material by making the pH of the slurry less than 8, and it is possible to make the radius of curvature larger.

Whatever the method, a case in which the etching rate of the non-magnetic base 1 is lower than the etching rate of the ferromagnet 3 is not desirable, as the surface of the ferromagnet 3 takes on a form wherein it is lower than the surface of the non-magnetic base 1.

### Magnetic Transfer Method

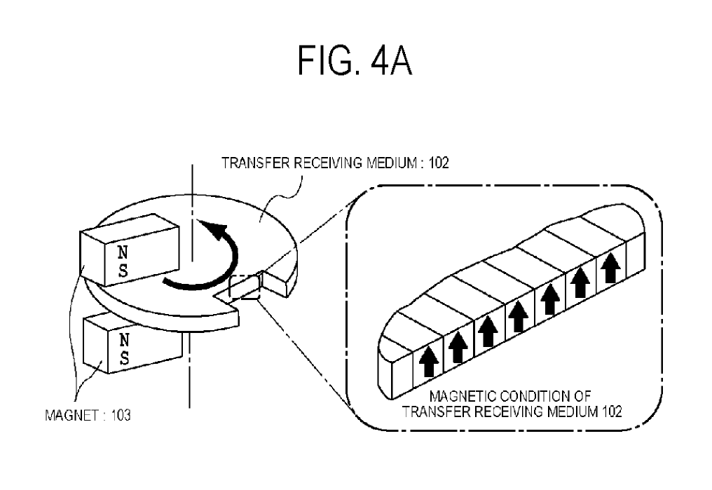

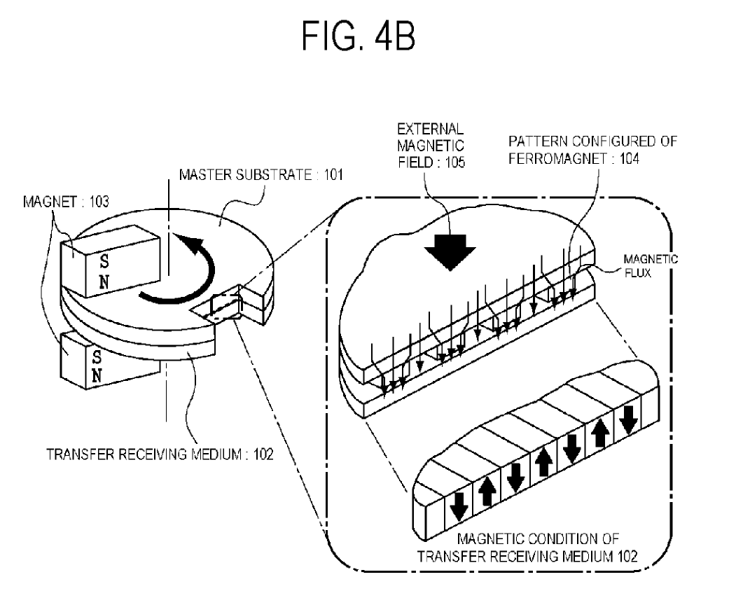

Next, a magnetic transfer method using the magnetic transfer master substrate obtained in the way heretofore described is shown in FIGS. 4a and 4b.

A magnetic transfer master substrate 101, a transfer receiving medium 102, and magnets 103 are prepared.

Firstly, a first external magnetic field is applied in an approximately perpendicular direction to the surface of the transfer receiving medium, magnetizing the transfer receiving medium 102 in one direction, as shown in FIG. 4a.

Subsequently, the transfer master substrate 101 and transfer receiving medium 102 are brought into contact, and an external magnetic field 105 of an orientation that is the reverse of the first magnetic field is applied in a direction approximately perpendicular to the recording surface of the transfer receiving medium, as in FIG. 4b. A pattern 104 configured of the ferromagnet being provided on the transfer master substrate 101, only a little magnetic flux passes through a portion in which the ferromagnet pattern formed on the master substrate 101 does not exist, and the orientation of the magnetization by the first magnetic field remains. As a large amount of magnetic flux passes through a portion in which the ferromagnet pattern exists, it is magnetized in the orientation of the second magnetic field 105. As a result, a magnetization pattern corresponding to the irregularities formed on the surface of the master substrate is transferred.

When the external magnetic field is applied, transfer may be carried out by the magnets 103 being disposed above and below the master substrate 101 and transfer receiving medium 102, and each of them rotating simultaneously, as in FIG. 4b.

Even in the event that the magnetic recording medium on which the magnetization pattern is recorded in the way heretofore described is one to which a transfer has been repeatedly made using a master substrate with a track pattern smaller than 100 nm, it is possible to have a sufficient servo signal strength, with no signal loss.

### EXAMPLES

Although examples of the invention are described hereafter, the following examples do not in any way limit the invention, and various changes may be made by those skilled in the art without departing from the scope of the invention.

### Example 1

Master Substrate Fabrication

The magnetic transfer master substrate of the invention is fabricated using the configuration shown in FIG. 1.

Firstly, a Si substrate of outer diameter 65 mm, inner diameter 20 mm, and thickness 0.635 mm is prepared, and a carbon film with a thickness of 80 nm is deposited using a sputtering method. The carbon film is pattern-processed in a subsequent step, becoming one portion of the non-magnetic base.

Next, an SOG resist is applied to a thickness of 70 nm using a spin coating method. A commercially available Tokyo Ohka Kogyo Co., Ltd. OCNL505 is used as the SOG.

Subsequently, an imprinting is carried out using a Ni stamper on which is formed a pattern corresponding to information to be transferred, forming an irregular pattern corresponding to the transfer pattern on the surface of the SOG. The pattern forming imprinting is carried out by superimposing the Ni stamper on the SOG resist surface of the substrate, carrying out a 100 MPa pressurization at room temperature for one minute, then removing the stamper. The pattern formed here corresponds to a track pitch of 60 nm.

As residual film exists in the pattern formed on the resist film by the imprinting, a residual film removal step is performed after the imprinting step. The SOG residual film is of 20 to 40 nm. The residual film removal is performed with a reactive ion etching (RIE) using CF₄ gas.

After the SOG residual film removal, the carbon film is etched with the irregular pattern formed on the SOG as a mask, forming an irregular pattern on the carbon film. The etching of the carbon film is performed with an RIE using O₂ gas. The processing depth is 80 nm, the same as the film thickness.

Subsequently, the SOG used as the mask is removed. The SOG removal is performed with an RIE using CF₄ gas. By the procedure thus far, the irregular pattern of the non-magnetic base 1 is formed.

Next, FeCo (Co 30%) is deposited as the ferromagnet 3, using a sputtering method, so that the thickness of a portion including a depressed portion of the non-magnetic base 1 is 200 nm, and the thickness of a portion not including a depressed portion is approximately 120 nm.

Subsequently, an etching is carried out with an RIE. The RIE processing is carried out for 252 seconds under conditions of RF power 100 W, substrate bias 20 W, 10% O₂ gas mixed with Ar gas, and degree of vacuum 0.1 Pa. Under these conditions, the etching rates separately measured previously in advance are 1.0 nm per second for the carbon film with respect to 0.5 nm per second for the FeCo.

A cross-sectional form of the master substrate fabricated in this way, when confirmed with a transmission electron microscope (TEM), is of a structure wherein the thickness of the ferromagnet 3 embedded in the depressed portions of the non-magnetic base 1 is 68 nm, the height h of the ferromagnet 3 protruding above the surface of the non-magnetic base 1 is 6 nm, and the radius of curvature r of a corner portion of the cross-section of the protruding ferromagnet 3 when cutting perpendicularly to the substrate is 4 nm.

### Example 2

### Fabrication of Samples of Various Cross-Sectional Forms

Various master substrates are fabricated, changing only the RIE conditions in the Example 1. The RIE conditions, and the cross-sectional forms of the master substrate observed with the TEM when cutting perpendicularly, are shown in Table 1.

TABLE 1
RIE conditions and master substrate cross-sectional forms observed with TEM

| | Condition | | | | | | | | |
|---|---|---|---|---|---|---|---|---|---|
| | | | | | | Cross-sectional Form | | | |
| | | | | | | | Height h of | | |
| | | | | | | Thickness of | Ferromagnetic | Radius of | |
| | RIE Condition | | | | | Ferromagnet | Material | Curvature r of | |
| | | | Gas Ratio; | | | Embedded in | Protruding | Corner | |
| | | | Flow Rate of | Degree | | Depressed | Above Surface | Portion of | |
| | | | O₂ Gas With | of | Processing | Portions of | of | Protruding | |
| Sample | Power | Substrate | Respect to | Vacuum | Time | Non-magnetic | Non-magnetic | Ferromagnet | |
| Number | (W) | Bias (W) | Ar Gas 100 | (Pa) | (sec.) | Base (nm) | Base (nm) | (nm) | Remarks |
| 1-1 | 200 | 20 | 10 | 0.2 | 252 | 68 | 6.0 | 4.0 | Example 1 |
| 1-2 | 200 | 20 | 10 | 0.2 | 245 | 75 | 2.5 | 2.0 | |
| 1-3 | 200 | 20 | 10 | 0.2 | 243 | 77 | 1.5 | 1.0 | |
| 1-4 | 200 | 20 | 10 | 0.2 | 260 | 60 | 10.0 | 6.5 | |
| 1-5 | 200 | 20 | 10 | 0.2 | 265 | 55 | 12.5 | 9.0 | |
| 1-6 | 200 | 20 | 10 | 0.2 | 270 | 50 | 15.0 | 11.0 | |
| 1-7 | 100 | 50 | 50 | 0.1 | 203 | 76 | 2.5 | 1.0 | |
| 1-8 | 100 | 50 | 50 | 0.1 | 204 | 74 | 3.5 | 1.5 | |
| 1-9 | 100 | 50 | 50 | 0.1 | 206 | 71 | 5.5 | 2.0 | |
| 1-10 | 100 | 50 | 50 | 0.1 | 210 | 65 | 9.0 | 3.5 | |
| 1-11 | 100 | 50 | 50 | 0.1 | 214 | 59 | 12.5 | 5.0 | |
| 1-12 | 100 | 50 | 50 | 0.1 | 218 | 53 | 16.0 | 6.0 | |
| 1-13 | 200 | 10 | 10 | 1.5 | 305 | 77 | 1.0 | 1.5 | |
| 1-14 | 200 | 10 | 10 | 1.5 | 308 | 75 | 1.5 | 2.0 | |
| 1-15 | 200 | 10 | 10 | 1.5 | 310 | 73 | 2.0 | 3.5 | |
| 1-16 | 200 | 10 | 10 | 1.5 | 312 | 72 | 3.5 | 4.5 | |
| 1-17 | 200 | 10 | 10 | 1.5 | 320 | 66 | 6.0 | 9.0 | |
| 1-18 | 200 | 10 | 10 | 1.5 | 328 | 60 | 8.5 | 11.0 | |
| 1-19 | 200 | 10 | 10 | 1.5 | 335 | 56 | 10.5 | 15.0 | |

In the example, by adopting RIE conditions of RIE power 100 to 200 W, substrate bias 10 to 50 W, O₂ gas flow rate with respect to Ar gas 100 10 to 50, degree of vacuum 0.1 to 1.5 Pa, and processing time 203 to 335 seconds, various kinds of master substrate are fabricated wherein the height h of the ferromagnet material protruding above the surface of the non-magnetic base is 1.0 to 16.0 nm, and the radius of curvature r of the corner portion of the protruding ferromagnet is 1.0 to 15.0 nm.

### Example 3

### Magnetic Transfer

A magnetic transfer of servo information to the magnetic recording medium is carried out using the master substrates fabricated in Examples 1 and 2. Furthermore, in order to investigate the repetition durability of the master substrate during the magnetic transfer, the magnetic transfer is carried out repeatedly while replacing the transfer receiving medium. In the repeating step, cleaning of the surface is carried out by wiping the surface of the master substrate with a tape every 1,000 times.

Servo Characteristic Evaluation

An evaluation of the servo characteristics on the magnetic recording media onto which the magnetic transfer is carried out using the heretofore described method is carried out for the first, ten thousandth, and one hundred thousandth magnetic recording media among the repetitions.

For the evaluation of the servo characteristics, a drive test is carried out using an evaluation drive. An evaluation of the possibility of servo following and reproduction signal output is carried out, and a determination is carried out based on the following evaluation standards. A signal output in a signal on portion is five times or more that in a signal off portion being required as a servo specification, for the following standards, O represents a pass, while Δ and x represent failures.

O: Servo following is possible, and the signal output in the signal on portion is five times or more that in the signal off portion

Δ: Servo following is possible, but the signal output in the signal on portion is less than five times that in the signal off portion

x: Servo following is not possible

TABLE 2
Servo Characteristic Evaluation Results for Each Kind of Sample

| | Condition | | | | | | |
|---|---|---|---|---|---|---|---|
| | Cross-sectional Form | | | Evaluation Result | | | |
| | Thickness of | Height h of | | | Ten | | |
| | Ferromagnet | Ferromagnetic | Radius of | | Thousandth | One Hundred | |
| | Embedded in | Material | Curvature r of | First | Magnetic | Thousandth | |
| | Depressed | Protruding | Corner Portion | Magnetic | Recording | Magnetic | |
| | Portions of | Above Surface | of Protruding | Recording | Medium | Recording | |
| Sample | Non-magnetic | of Non-magnetic | Ferromagnet | Medium Servo | Servo | Medium Servo | Overall |
| Number | Base (nm) | Base (nm) | (nm) | Characteristics | Characteristics | Characteristics | Determination |
| 1-1 | 68 | 6.0 | 4.0 | ◯ | ◯ | ◯ | Pass |
| 1-2 | 75 | 2.5 | 2.0 | ◯ | ◯ | ◯ | Pass |
| 1-3 | 77 | 1.5 | 1.0 | Δ | Δ | X | Fail |
| 1-4 | 60 | 10.0 | 6.5 | ◯ | ◯ | ◯ | Pass |
| 1-5 | 55 | 12.5 | 9.0 | ◯ | ◯ | ◯ | Pass |
| 1-6 | 50 | 15.0 | 11.0 | Δ | Δ | Δ | Fail |
| 1-7 | 76 | 2.5 | 1.0 | ◯ | Δ | X | Fail |
| 1-8 | 74 | 3.5 | 1.5 | ◯ | ◯ | Δ | Fail |
| 1-9 | 71 | 5.5 | 2.0 | ◯ | ◯ | ◯ | Pass |
| 1-10 | 65 | 9.0 | 3.5 | ◯ | ◯ | ◯ | Pass |
| 1-11 | 59 | 12.5 | 5.0 | ◯ | ◯ | ◯ | Pass |
| 1-12 | 53 | 16.0 | 6.0 | ◯ | ◯ | Δ | Fail |
| 1-13 | 77 | 1.0 | 1.5 | Δ | Δ | X | Fail |
| 1-14 | 75 | 1.5 | 2.0 | Δ | Δ | Δ | Fail |
| 1-15 | 73 | 2.0 | 3.5 | ◯ | ◯ | ◯ | Pass |
| 1-16 | 72 | 3.5 | 4.5 | ◯ | ◯ | ◯ | Pass |
| 1-17 | 66 | 6.0 | 9.0 | ◯ | ◯ | ◯ | Pass |
| 1-18 | 60 | 8.5 | 11.0 | Δ | Δ | Δ | Fail |
| 1-19 | 56 | 10.5 | 15.0 | Δ | Δ | Δ | Fail |

According to the results in Table 2, with samples wherein the form of the master substrate is such that, one portion of the ferromagnet in the depressed portions of the non-magnetic base being embedded in such a way as to protrude above the surface of the non-magnetic base, the height h of the ferromagnetic material protruding above the surface of the non-magnetic base is 2 nm or more, 15 nm or less, and the radius of curvature r of a corner portion of the cross-sectional form of the portion of the ferromagnet protruding above the surface is 2 nm or more, 10 nm or less, as with samples 1-1, 1-2, 1-4, 1-5, 1-9 to 1-11, and 1-15 to 1-17, it is possible to obtain a magnetic transfer medium that maintains good servo characteristics even after the magnetic transfer is repeated 100,000 times.

Meanwhile, with samples wherein the height h of the ferromagnet protruding above the surface of the sample non-magnetic base is less than 2 nm, as with samples 1-3, 1-13, and 1-14, servo following is possible from the servo characteristics of the first magnetic transfer, but the signal output in the signal on portion is less than five times that in the signal off portion, resulting in failure. When the servo portions of these transfer receiving media are checked with a magnetic force microscope (MFM), there are portions of weak magnetic force here and there in the magnetization pattern. Because of this, it is thought that the reason for the signal output being less than five times is that a place where the contact with the transfer receiving medium is low occurs in one portion of the ferromagnet pattern, and sufficient magnetization is not carried out.

Also, with samples wherein the radius of curvature r of the corner portion of the protruding ferromagnet is larger than 10 nm too, as with samples 1-6, 1-18, and 1-19, servo following is possible even with the servo characteristics of the first magnetic transfer, but the signal output in the signal on portion is less than five times that in the signal off portion, resulting in failure. When the servo portions of these transfer receiving media are checked with an MFM, the individual edges of the magnetization pattern are unclear. Because of this, it is thought that the reason for the signal output being less than five times is that the magnetic force of the edge portions of the magnetization pattern becomes weak due to the curvature of the corner portion of the ferromagnet being too large.

Also, with a sample wherein the height h of the ferromagnetic material protruding above the surface of the sample non-magnetic base is greater than 15 nm, as with sample 1-12, the servo characteristics of the first magnetic transfer pass but, although servo following is possible from the servo characteristics of the one hundred thousandth magnetic transfer, the signal output in the signal on portion is less than five times that in the signal off portion, resulting in failure. When the servo portions of this transfer receiving medium are checked with an MFM, there are portions of weak magnetic force here and there in the magnetization pattern. Because of this, it is thought that the reason for the signal output being less than five times is that a loss occurs in one portion of the ferromagnet pattern of the master substrate during repeated use, and a loss of transfer to the transfer receiving medium occurs in one portion of the pattern.

Also, with samples wherein the radius of curvature r of the corner portion of the protruding ferromagnet is less than 2 nm too, as with samples 1-3, 1-7, 1-8, and 1-13, the servo characteristics of the one hundred thousandth magnetic transfer deteriorate in comparison with the servo characteristics of the first magnetic transfer, resulting in failure. When the servo portions of these transfer receiving media are checked with an MFM, there are portions of weak magnetic force here and there in the magnetization pattern. Because of this, it is thought that the reason for the signal output being less than five times is that a loss occurs in one portion of the ferromagnet pattern of the master substrate during repeated use, and a loss of transfer to the transfer receiving medium occurs in one portion of the pattern.

When the ferromagnet pattern form of the master substrate is such that the cross-sectional form of the portion of the ferromagnet protruding above the surface is such that the radius of curvature r of the corner portion is 2 nm or more, 10 nm or less, and the height h of the portion of the ferromagnet protruding above the surface is 2 nm or more, 15 nm or less, as heretofore described, it is possible to obtain a magnetic transfer medium with good servo characteristics even when repeating the magnetic transfer 100,000 times.

### Example 4

Next, the effect of the track pitch on the durability will be shown.

Samples with track pitches of 45 nm, 100 nm, 125 nm, and 200 nm are fabricated and evaluated with a fabrication method and measurement and evaluation conditions equivalent to those in Examples 1 to 3. The results are shown in Table 3. Also, the samples 1-8, 1-12, 1-14, and 1-18 in Examples 1 to 3 are shown as a comparison.

TABLE 3
Servo Characteristic Evaluation Results for Each Kind of Sample

| | Condition | | | | | | |
|---|---|---|---|---|---|---|---|
| | | Cross-sectional Form | | Evaluation Result | | | |
| | | Height h of | | | Ten | | |
| | | Ferromagnetic | | | Thousandth | One Hundred | |
| | | Material | | First | Magnetic | Thousandth | |
| | Pattern | Protruding Above | Radius of Curvature | Magnetic | Recording | Magnetic | |
| | Track | Surface of | r of Corner Portion | Recording | Medium | Recording | |
| Sample | Pitch | Non-magnetic Base | of Protruding | Medium Servo | Servo | Medium Servo | Overall |
| Number | (nm) | (nm) | Ferromagnet (nm) | Characteristics | Characteristics | Characteristics | Determination |
| 2-1 | 45 | 3.5 | 1.5 | Δ | X | X | Fail |
| 1-8 | 60 | 3.5 | 1.5 | ◯ | ◯ | Δ | Fail |
| 2-2 | 100 | 3.5 | 1.5 | ◯ | ◯ | Δ | Fail |
| 2-3 | 125 | 3.5 | 1.5 | ◯ | ◯ | ◯ | Pass |
| 2-4 | 200 | 3.5 | 1.5 | ◯ | ◯ | ◯ | Pass |
| 2-13 | 45 | 8.5 | 11.0 | X | X | X | Fail |
| 1-18 | 60 | 8.5 | 11.0 | Δ | Δ | Δ | Fail |
| 2-14 | 100 | 8.5 | 11.0 | Δ | Δ | Δ | Fail |
| 2-15 | 125 | 8.5 | 11.0 | ◯ | ◯ | ◯ | Pass |
| 2-16 | 200 | 8.5 | 11.0 | ◯ | ◯ | ◯ | Pass |
| 2-9 | 45 | 1.5 | 2.0 | Δ | X | X | Fail |
| 1-14 | 60 | 1.5 | 2.0 | Δ | Δ | Δ | Fail |
| 2-10 | 100 | 1.5 | 2.0 | Δ | Δ | Δ | Fail |
| 2-11 | 125 | 1.5 | 2.0 | ◯ | ◯ | ◯ | Pass |
| 2-12 | 200 | 1.5 | 2.0 | ◯ | ◯ | ◯ | Pass |
| 2-5 | 45 | 16.0 | 6.0 | ◯ | Δ | x | Fail |
| 1-12 | 60 | 16.0 | 6.0 | ◯ | ◯ | Δ | Fail |
| 2-6 | 100 | 16.0 | 6.0 | ◯ | ◯ | Δ | Fail |
| 2-7 | 125 | 16.0 | 6.0 | ◯ | ◯ | ◯ | Pass |
| 2-8 | 200 | 16.0 | 6.0 | ◯ | ◯ | ◯ | Pass |
| 3-1 | 45 | 3.5 | 2.0 | ◯ | ◯ | ◯ | Pass |
| 3-2 | 45 | 8.5 | 6.0 | ◯ | ◯ | ◯ | Pass |
| 3-3 | 100 | 3.5 | 2.0 | ◯ | ◯ | ◯ | Pass |
| 3-4 | 100 | 8.5 | 6.0 | ◯ | ◯ | ◯ | Pass |

According to the results in Table 3, when the track pitch is 125 nm or more, the servo characteristics pass as far as the one hundred thousandth magnetic recording medium, regardless of the heretofore described ranges, but when the track pitch is 100 nm or less, the servo characteristics fail unless the radius of curvature r of the corner portion of the cross-sectional form of the portion of the ferromagnet protruding above the surface is 2 nm or more, 10 nm or less, and the height h of the portion of the ferromagnet protruding above the surface is 2 nm or more, 15 nm or less.

When the track pitch is more than 125 nm, as with samples 2-3, 2-4, 2-7, and 2-8, it is thought that as the volume of the embedded magnetic body is large, a defect such as a detachment of the ferromagnet is unlikely to occur during repeated use, the durability increases, and even the servo characteristics of the one hundred thousandth magnetic recording medium pass, even when the radius of curvature r of the corner portion of the protruding ferromagnet is less than 2 nm, and even when the height h of the portion of the ferromagnet protruding above the surface is greater than 15 nm. Also, even when the radius of curvature r of the corner portion is greater than 10 nm, and even when the height h of the portion of the ferromagnet protruding above the surface is less than 2 nm, it is thought that as the volume of the embedded magnetic body is large when the track pitch is more than 125 nm, as with samples 2-11, 2-12, 2-15, and 2-16, it is possible to obtain an amount of magnetization sufficient to reverse the magnetization of the transfer medium.

That is, it is shown that when the track pattern is less than 100 nm, it is necessary that the form of the master substrate is such that the cross-sectional form of the portion of the ferromagnet protruding above the surface is such that the radius of curvature r of the corner portion is 2 nm or more, 10 nm or less, and the height h of the portion of the ferromagnet protruding above the surface is 2 nm or more, 15 nm or less, in order to have durability and a sufficient magnetic transfer performance.

It will be understood that the above description of the exemplary embodiments of the invention are susceptible to various modifications, changes and adaptations, and the same are intended to be comprehended within the meaning and range of equivalents of the appended claims.

What is claimed is:

1. A magnetic transfer master substrate having a ferromagnet pattern corresponding to a signal array for transferring an information signal therein to a magnetic recording medium, the substrate comprising:
a non-magnetic base having depressed portions, formed on a surface thereof, corresponding to the signal array; and
a ferromagnet, disposed in the depressed portions and including a portion protruding above said surface, wherein
a section through the portion of the ferromagnet protruding from said surface, taken perpendicularly to a surface of the substrate, includes a curved corner, a radius of curvature of which is no less than 2 nm and no more than 10 nm, and
the ferromagnet protrudes from said surface of the base by a distance no less than 2 nm and no more than 15 nm.

2. The magnetic transfer substrate according to claim 1, wherein the magnetic transfer master substrate has a track pattern smaller than 100 nm.

3. The magnetic transfer substrate according to claim 1, wherein the base is formed of a material selected from the group consisting of Si, SiO₂, Al, Al₂O₃, and compounds thereof.

4. The magnetic transfer substrate according to claim 1, wherein the ferromagnet is formed of a material selected from the group consisting of Fe, Co, Cr, Ni, and compounds thereof.

5. The magnetic transfer substrate according to claim 1, wherein the curved corner is a rounded corner having a uniform curvature.

6. A magnetic transfer method comprising:
bringing the master substrate according to claim 1 and a magnetic recording medium into contact, one on top of the other;
applying a magnetic field to the contacting master substrate and magnetic recording medium, and recording a magnetization pattern corresponding to the ferromagnet pattern of the master substrate, on the magnetic recording medium; and
separating the contacting master substrate and magnetic recording medium.

7. A method of manufacturing a magnetic transfer master substrate having a ferromagnet pattern corresponding to a signal array for transferring an information signal therein to a magnetic recording medium, the method comprising:
providing a non-magnetic base;
forming depressed portions, corresponding to the signal array, in a surface of the base;
depositing a ferromagnet on said surface of the base, including in the depressed portions; and
etching the base and the ferromagnet at a lower etching rate for the ferromagnet than for the base so as to form the ferromagnet pattern, wherein
the ferromagnet protrudes from said surface by a distance no less than 2 nm and no greater than 15 nm, and
a section of the ferromagnet that protrudes from said surface of the base, and that is taken perpendicularly to a surface of the substrate, includes a curved corner, a radius of curvature of which is no less than 2 nm and no more than 10 nm.

8. The method according to claim 7, wherein the ferromagnet is deposited such that a top surface of the ferromagnet is flat.

9. The method according to claim 7, wherein a ratio of the etching rate of the ferromagnet to the etching rate of the base is 1 to 50.

10. The method according to claim 7, wherein a ratio of the etching rate of the ferromagnet to the etching rate of the base is 2 to 5.

11. The method according to claim 7, wherein said etching includes reactive ion etching, further comprising controlling an RF power and a substrate bias during said reactive ion etching.

12. The method according to claim 11, wherein a ratio of the RF power to the substrate bias is 1 to 50.

13. The method according to claim 11, wherein a ratio of the RF power to the substrate bias is 1 to 20.

14. The method of claim 11, wherein the RF power is in the range of 10 W to 1,500 W.

15. The method of claim 11, wherein the substrate bias is in the range of 5 W to 800 W.

16. The method according to claim 7, wherein said etching includes chemical mechanical polishing.

17. The method according to claim 16, wherein said chemical mechanical polishing includes etching with a slurry that has a pH of less than 8.

18. The method according to claim 7, wherein the magnetic transfer master substrate has a track pattern smaller than 100 nm.

19. The method according to claim 7, wherein the curved corner is a round corner having a uniform curvature.
